(19) United States
(12) Patent Application Publication
(10) Pub. No.: US 2010/0311421 A1
(43) Pub. Date: Dec. 9, 2010

(54) Methods and Apparatus for Communications Terminal Enabling Self Optimizing Networks in Air Interface Communications Systems

(76) Inventor: Tomasz Mach, Hampshire (GB)

Correspondence Address: SLATER & MATSIL, L.L.P., 17950 PRESTON RD, SUITE 1000, DALLAS, TX, 75252-5793, US

(21) Appl. No.: 12/479,324

(22) Filed: Jun. 5, 2009

(51) Int. Cl. H04W 36/00

(52) U.S. Cl. 455/436

(57) ABSTRACT

Systems and methods for providing a framework for supporting a self organizing/optimization network (SON) feature in an over the air communications system. An enhanced mobile communications device is provided that performs functions to creating a framework for enhancing SON algorithms. The communications device stores event analysis data in an on board memory and, on certain conditions, signals the analysis to the network. The analysis includes information useful in performing SON algorithms at the network level, such as cell coverage and neighboring cell signal level information, cell selection and reselection information at different locations, relative signal strength between cell base stations at different locations, and coverage hole information. Utilizing the stored information, the network can automatically perform SON algorithms to improve network efficiency without the need for manual intervention by an operator. Embodiments include event filtering by the communications device to efficiently utilize the on board storage.

### TECHNICAL FIELD

The present invention is directed, in general, to communications systems and, more particularly, to methods and apparatus for providing improved self organizing/optimizing networks (SON) by providing communications terminals that enable and support self organizing/optimizing network algorithms in communications systems using spread spectrum signaling over an air interface, such as UTRAN, evolved UTRAN or LTE, and/or next generation mobile networks (NGMN) systems.

### BACKGROUND

As wireless communications systems such as cellular telephone, satellite, and microwave communications systems become widely deployed and continue to attract a growing number of users, there is a pressing need to accommodate a large and variable number of communications subsystems transmitting a growing volume of data with a fixed resource such as a fixed channel bandwidth accommodating a fixed data packet size. Traditional communications system designs employing a fixed resource (e.g., a fixed data rate for each user) have become challenged to provide high, but flexible, data transmission rates in view of the rapidly growing customer base.

For wireless communications providing data intensive broadband services such as internet access and multimedia services provided over an air interface communications system, the need for improved efficiency and rapid throughput is of great importance. The 3G technology is generally defined by a body of standards released by the 3GPP organization and available at www.3gpp.org. The extension from present networks to the next generation of UTRAN or 3G networks is generally termed the “Long Term Evolution” or LTE. These LTE standards are also being provided by and supported by the 3GPP organization and the networks implementing these standards are usually referred to as evolved UTRAN or e-UTRAN.

The third generation partnership project long term evolution (“3GPP LTE”) is the name generally used to describe an ongoing effort across the industry to improve the universal mobile telecommunications system (“UMTS”) for mobile communications. The improvements are being made to cope with continuing new requirements and the growing base of users, and higher data rates and higher system capacity requirements. Goals of this broadly based project include improving communication efficiency, lowering costs, improving services, making use of new spectrum opportunities, and achieving better integration with other open standards and backwards compatibility with some existing infrastructure that is compliant with earlier standards. Further, the NGMN project builds additional capabilities onto the 3G environment.

The wireless communications systems as described herein are applicable to, for instance, 3GPP LTE compatible wireless communications systems and of interest is an aspect of LTE referred to as “evolved UMTS Terrestrial Radio Access Network,” or E-UTRAN and also UTRAN communications systems. In E-UTRAN systems, the e-Node B may be, or is, connected directly to the access gateway (“aGW,” sometimes referred to as the services gateway “sGW”). Each Node B may be in radio contact with multiple UEs (generally, user equipment including mobile transceivers or cellphones, although other devices such as fixed cellular phones, mobile web browsers, laptops, PDAs, MP3 players, and gaming devices with transceivers may also be UEs) via the radio Uu interface.

In the present discussion, particular attention is paid to enhancements presently being considered for Release 9 and Release 10 (sometimes referred to as “LTE Advanced”) of the 3GPP standards. These future evolutions of LTE will have additional requirements and demands for increased throughput. Although the discussion uses NGMN and E-UTRAN as the primary example, the application is not limited to E-UTRAN, LTE or 3GPP systems. LTE is a packet-based system and, therefore, there may not be a dedicated connection reserved for communications between a UE and the network. Users are generally scheduled on a shared channel every transmission time interval (“TTI”) by a Node B or an evolved Node B (“e-Node B”). A Node B or an e-Node B controls the communications between user equipment terminals in a cell served by the Node B or e-Node B. In general, one Node B or e-Node B serves each cell. A Node B or e-Node B may be referred to as a “base station.” Resources needed for data transfer are assigned either as one time assignments or in a persistent/semi-static way. The LTE, also referred to as 3.9G, generally supports a large number of users per cell with quasi-instantaneous access to radio resources in the active state. It is a design requirement that at least 200 users per cell should be supported in the active state for spectrum allocations up to 5 megahertz (“MHz”), and at least 400 users for a higher spectrum allocation.

In order to facilitate scheduling on the shared channel, the e-Node B transmits a resource allocation to a particular UE in a physical downlink channel control channel (“PDCCH”) to the UE. The allocation information may be related to both uplink and downlink channels. The allocation information may include information about which resource blocks in the frequency domain are allocated to the scheduled user(s), the modulation and coding schemes to use, what the size of the transport block is, and the like.

The lowest layer of communications in the UTRAN or e-UTRAN system, Layer 1, is implemented by the Physical Layer (“PHY”) in the UE and in the Node B or e-Node B. The PHY performs the physical transport of the packets between them on an over the air interface using radio frequency signals. In order to ensure a transmitted packet was received, an automatic retransmit request (“ARQ”) and a hybrid automatic retransmit request (“HARQ”) approach is provided. Thus, whenever the UE receives packets through one of several downlink channels, including dedicated channels and shared channels, the UE performs a communications error check on the received packets, typically a Cyclic Redundancy Check (“CRC”), and in a later subframe following the reception of the packets, transmits a response on the uplink to the e-Node B or base station. The response is either an Acknowledge (“ACK”) or a Not Acknowledged (“NACK”) message. If the response is a NACK, the e-Node B automatically retransmits the packets in a later subframe on the downlink (“DL”). In the same manner, any uplink (“UL”) transmission from the UE to the e-Node B is responded to, at a specific subframe later in time, by a NACK/ACK message on the DL channel to complete the HARQ. In this manner, the packet communications system remains robust with a low latency time and fast turnaround time.

Further, an organization providing standardized goals for the next generation mobile networks, or NGMN, is providing a standard set of features the next generation of mobile networks should support. A white paper entitled “Next Generation Mobile Networks Beyond HSPA & EVDO”, available at www.ngmn.org, which is hereby incorporated herein by reference in its entirety, provides requirements for proposed advanced mobile communications networks.

A proposal currently adopted for next generation networks includes requirements for Self Organizing/Optimizing Networks (“SON”). The SON concept provides some features and example cases illustrating capabilities needed to support automatic radio access network (RAN) optimization. The paper entitled “Next Generation Mobile Networks-beyond HSPA & EVDO” provides several features that are to be supported by future networks. SON networks that comply with the NGMN proposals should provide “Self-Planning”, which includes derivation of initial network parameters as input for a self configuration instance; “Self-Configuration”, which includes “plug and play” behavior in newly installed elements in the network to simplify network installations; “Self Optimization and Self-Tuning”, which is based on network monitoring and measurement data to increase performance; and “Self Testing and Self Healing” in which the system detects problems and takes action to avoid user impact and reduce costs.

A similar proposal from the 3GPP organization is provided in the technical specification (TS) titled “Self-Configuring and Self-Optimizing Network Use Cases and Solutions” (Release 8), numbered 3GPP TR 36.902 v 1.0.0 (2008-02). This document provides “use cases” which describe proposed improvements to the networks. The document is available at www.3gpp.org and is hereby incorporated in its entirety herein by reference.

Thus, both the NGMN and 3GPP organizations have defined SON as a feature of future networks. However, as the standard proposals are presently provided, no user equipment (UE) algorithms or features are described which could provide valuable input into the SON algorithms performed by the base station or Node B, or the radio resource controller (RRC), to perform the SON algorithms.

A need thus exists for methods and apparatus to efficiently provide added support for SON algorithms by providing UEs that signal certain input data that may be used by the network to perform SON without the need for manual operator inputs.

### SUMMARY OF THE INVENTION

These and other problems are generally solved or circumvented, and technical advantages are generally achieved, by advantageous embodiments of the present invention which include an apparatus and methods according to embodiments that provide a UE framework cell reselection data signaled to the network that provides useful data for the SON algorithms. The embodiment UE framework addresses some of the proposed SON use cases, including without limitation Coverage Optimization, Coverage Hole Management, eNB Insertion/Removal, and Handover Optimization.

Embodiments provide a UE related framework that supports SON algorithms. In one embodiment, UE measurements of relative and absolute cell signal power are performed as defined by the 3GPP specification. Depending on the outcome of cell selection and reselection processes performed by the UE, different reselection events may be defined. Those events are defined by the outcome of certain cell reselection procedures performed during terminal mobility. The resulting reselection events may be stored in a memory provided within the UE, and may be reported to various network entities using signaling messages.

In one embodiment, the UE reports these events during cell location and cell update procedures requested by a network entity or initiated by UE. The reports are based on predefined reporting criteria provided to the UE. In some embodiments, the measurements are related to the idle mode of UE operation, that is, measurements by the UE are made when no signaling operation is active (no connection to the UE by the RRC is active).

In one exemplary embodiment, while the UE is in an idle mode, cell reselection may be performed. The cell reselection processes are intended to select the best cell for the UE to reliably obtain service. Because the UE is a mobile device, from time to time it moves from one cell coverage area to another. When the UE moves out of a coverage area, it performs received signal strength measurements on neighboring cells to identify a new cell. When the power of the present serving cell decreases below a predefined received signal power threshold, the UE decides to perform a reselection procedure to select a new cell. The current serving cell and any neighboring cells are evaluated in accordance with a serving cell criteria threshold; these may be provided by the network. The UE may or may not successfully reselect to a new cell. In embodiments of the present invention, the UE may store a cell reselection event analysis result after an attempted or successful reselection. In some embodiments, the stored event analysis may include the cell IDs of the service cell, the neighbor cells, the type of reselection event, and the location of the UE and date and time information, or any of these. The events stored may be provided to the network to input into SON algorithms to improve the SON procedures.

In additional embodiments, the network receives the events from the UE and performs an analysis based on the information and recommends certain configurations to the network configuration to enhance the SON algorithms.

In additional embodiments, the network provides certain criteria to the UE to aid in determining which events to store in UE memory. By selectively controlling the UE storing mechanisms, the network increases the efficient use of the limited memory capacity of the UE.

In additional embodiments, the network may provide filtering criteria for events so that the UE only stores events of specific interest to a network. In other embodiments, the UE may only report events when certain criteria are met to advantageously reduce the frequency of events reporting to the network.

Embodiments of the invention provide methods for performing idle mode measurements by a UE that support the SON algorithms performed by a network using only software or firmware changes to existing equipment. No hardware changes, redesigns, or replacements are necessary to implement the embodiments of the invention. However, the enhancements of the embodiments could be implemented with hardware modifications, software modifications, both, or either one as alternative embodiments. Each of these is contemplated as part of the invention and is within the scope of the claims.

Additional exemplary embodiments of the present invention include providing UEs that support certain 3GPP test minimization use cases without any hardware redesigns. The various embodiments may be added to an industry standard for implementation. Alternatively, the embodiments may be implemented in certain equipment without affecting the use of equipment that does not implement the embodiments; that is, the use of the embodiments is also compatible with prior art devices and no compatibility or interoperability problems will arise by use of the embodiments.

The embodiments may be implemented using programmable processors and executable software. For example, the embodiments may be implemented as a computer readable storage product, comprising executable instructions which, when read and executed by a programmable communications terminal, cause the programmable communications terminal to perform storing the cell reselection event type in a memory on board the programmable communications terminal. The computer readable storage product may be provided as a flash drive, disk, optical disk, hard drive, file, internet download or other machine readable format.

The foregoing has outlined rather broadly the features and technical advantages of the present invention so that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, reference is now made to the following descriptions taken in conjunction with the accompanying drawings, in which:

FIG. 1 illustrates a communications system with communications terminals;

FIG. 2 illustrates a block diagram of a communications device according to an advantageous embodiment of the present invention;

FIG. 3 illustrates a block diagram of the communications elements of FIG. 1 and the service layers used in the communications system;

FIG. 4 illustrates a block diagram of a network operation with a communications element in contact with two base station cells;

FIG. 5 illustrates in a simple block diagram a reselection event of a preferred embodiment communications terminal;

FIG. 6 illustrates in another simple block diagram a reselection event of a preferred embodiment communications terminal;

FIG. 7 illustrates in another simple block diagram another reselection event of a preferred embodiment communications terminal;

FIG. 8 illustrates in a graph a variety of events that a communications element of the present invention may perform;

FIG. 9 depicts in a flow chart actions taken by embodiments of communications terminals incorporating the invention; and

FIG. 10 depicts an embodiment table for use with communications terminals incorporating features of the invention.

### DETAILED DESCRIPTION

These and other problems are solved, and advantages are achieved, by embodiments of the present invention.

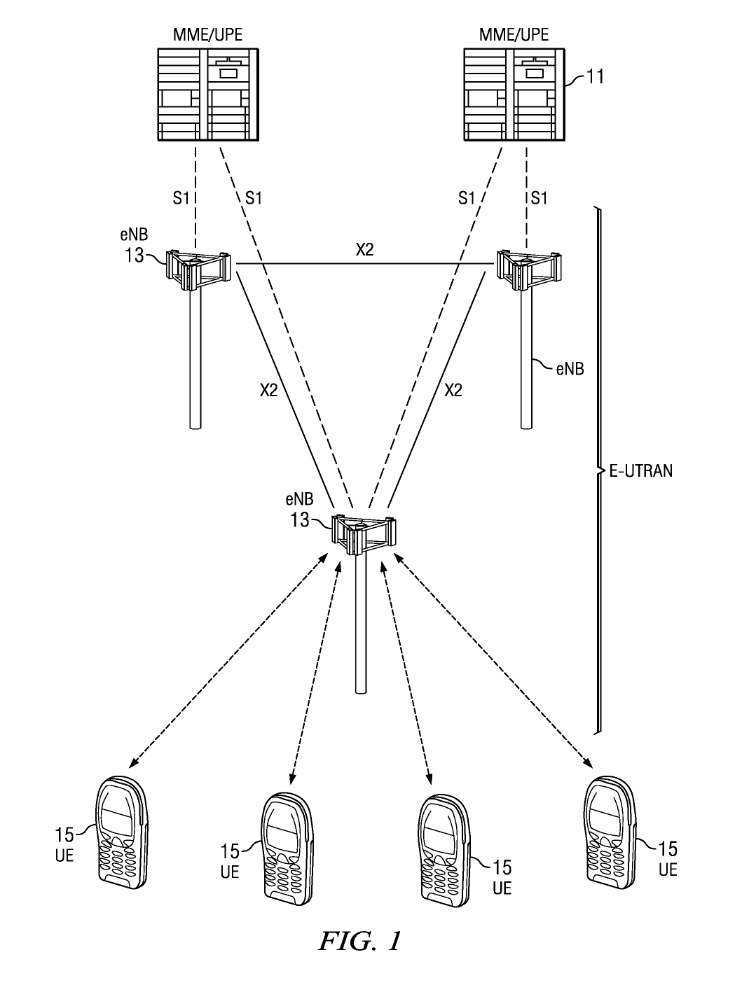

Referring initially to FIG. 1, illustrated is a system level diagram of a radio frequency interface communications system including a wireless communications system that provides an environment for the application of the principles of the present invention. The wireless communications system may be configured to provide features included in the evolved UMTS terrestrial radio access network (“e-UTRAN”) universal mobile telecommunications services. Mobile management entities (“MMEs”) and user plane entities (“UPEs”) 11 provide control functionality for e-UTRAN node B (designated “eNB,” an “evolved node B,” also commonly referred to as a “base station”) 13 via S1 interfaces or communications links. The base stations 13 communicate via an X2 interface or communications link. The various communications links are typically fiber, microwave, or other high-frequency metallic communications paths such as coaxial links, or combinations thereof.

The base stations 13 communicate over an air interface with user equipment (designated “UE”) 15, which is typically a mobile transceiver carried by a user. Alternatively, the user equipment may be a mobile web browser, text messaging appliance, a laptop with a mobile PC modem, or other user device configured for cellular or mobile services. Thus, communications links coupling the base stations 13 to the user equipment 15 are air links employing a wireless communications signal. For example the devices may communicate using a known signaling approach such as a 1.8 GHz orthogonal frequency division multiplex (“OFDM”) signal. Other radio frequency signals may be used.

The eNBs 13 may host functions such as radio resource management (e.g. internet protocol (“IP”), header compression and encryption of user data streams, ciphering of user data streams, radio bearer control, radio admission control, connection mobility control, dynamic allocation of resources to user equipment in both the uplink and the downlink), selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling.

The MME/UPEs 11 may host functions such as distribution of paging messages to the base stations, security control, terminating U-plane packets for paging reasons, switching of U-plane for support of the user equipment mobility, idle state mobility control, and system architecture evolution bearer control. The UEs 15 receive an allocation of a group of information blocks labeled physical resource blocks (“PRBs”) from the eNBs. Each base station has a reception area, usually referred to as a “cell” and may serve a plurality of UEs 15 at any given time. The UEs are mobile devices and as the location of the UEs 15 changes, the UEs and the eNBs will perform “soft handoff” or “handoff” procedures. For an active user these handoffs will be transparent and no loss of service or audible change should occur.

The UE may also be in an “idle” mode; however, in order to remain available to receive or make calls, the UE will select and “camp” on a nearby cell by selecting or reselecting an eNB. As will be described in more detail later herein, the UE will perform measurements to determine, between possible cells that it can receive signals from, which to “camp” on and when to change serving cells by performing “reselection”.

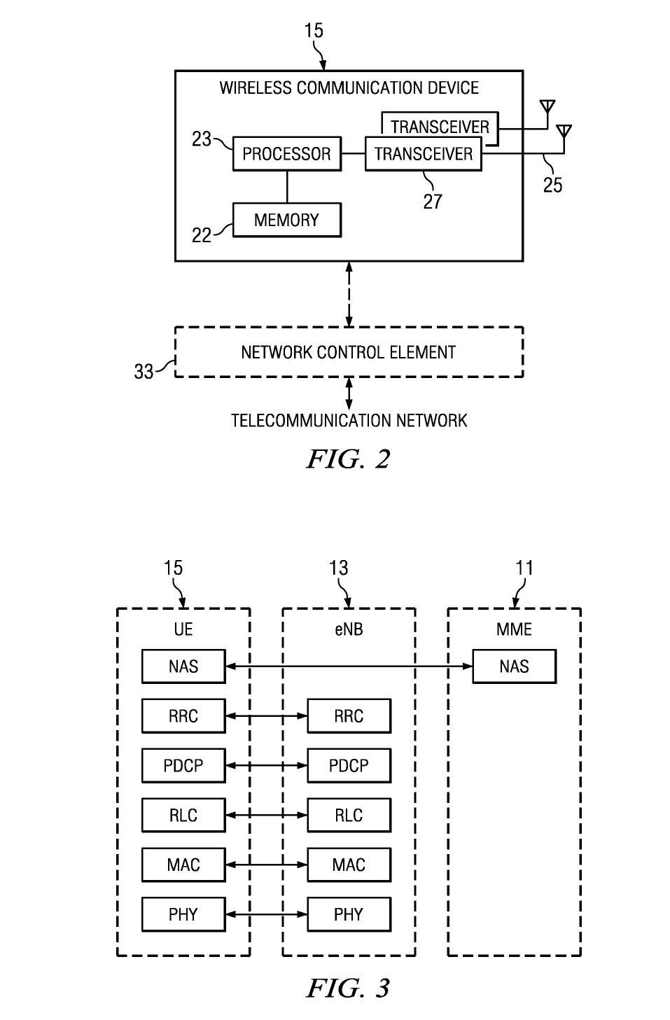

FIG. 2 illustrates a simplified system level diagram of an example communications device 15 of a communications system. Device 15 provides an environment and structure for application of the principles of the present invention. The communications device may represent, without limitation, an apparatus including an eNB, UE such as a terminal or mobile station, a network control element, or the like. The communications device 15 includes, at least, a processor 23, memory 22 that stores programs and data of a temporary or more permanent nature, one or more antennas 25, and one or more radio frequency transceivers 27 coupled to the antenna(s) 25 and the processor 23 for bidirectional wireless communications. Other functions may also be provided. The communications device 15 may provide point-to-point and/or point-to-multipoint communications services.

The communications device, such as an eNB in a cellular network, may be coupled to a communications network element, such as a network control element 33 of a public switched telecommunications network (“PSTN”). The network control element 33 may, in turn, be formed with a processor, memory, and other electronic elements (not shown). Access to the PSTN may be provided using fiber optic, coaxial, twisted pair, microwave communications, or similar communications links coupled to an appropriate link-terminating element. A communications device 15 formed as a UE is generally a self-contained device intended to be carried by an end user and communicating over an air interface to other elements in the network.

The processor 23 in the communications device 15, which may be implemented with one of or a plurality of processing devices, performs functions associated with its operation including, without limitation, encoding and decoding of individual bits forming a communications message, formatting of information, and overall control of the communications device, including processes related to management of resources. Exemplary functions related to management of resources include, without limitation, hardware installation, traffic management, performance data analysis, tracking of end users and mobile stations, configuration management, end user administration, management of the mobile station, management of tariffs, subscriptions, billing, and the like. The execution of all or portions of particular functions or processes related to management of resources may be performed in equipment separate from and/or coupled to the communications device, with the results of such functions or processes communicated for execution to the communications device. The processor 23 of the communications device 15 may be of any type suitable to the local application environment, and may include one or more of general purpose computers, special purpose computers, microprocessors, digital signal processors (“DSPs”), and processors based on a multi-core processor architecture, as non-limiting examples.

The transceiver(s) 27 of the communications device 15 modulates information onto a carrier waveform for transmission by the communications device via the antenna(s) 25 to another communications device. The transceiver demodulates information received via the antenna for further processing by other communications devices.

The memory 22 of the communications device 15, as introduced above, may be of any type suitable to the local application environment, and may be implemented using any suitable volatile or nonvolatile data storage technology, such as a semiconductor-based memory device, a magnetic memory device and system, an optical memory device and system, fixed memory, and removable memory. The programs stored in the memory 22 may include program instructions that, when executed by an associated processor, enable the communications device to perform tasks as described herein. Exemplary embodiments of the systems, subsystems, and modules as described herein may be implemented, at least in part, by computer software executable by processors of, for instance, the mobile station and the base station, by hardware, or by combinations thereof. Other programming may be used such as firmware and/or state machines. As will become more apparent, systems, subsystems and modules may be embodied in the communications device as illustrated and described above.

FIG. 3 depicts a block diagram of an embodiment of a UE 15 and an eNB 13 constructed according to the principles of the present invention and coupled to an MME 11. The UE 15 and the eNB 13 each include a variety of layers and subsystems: the physical layer (“PHY”) subsystem, a medium access control layer (“MAC”) subsystem, a radio link control layer (“RLC”) subsystem, a packet data convergence protocol layer (“PDCP”) subsystem, and a radio resource control layer (“RRC”) subsystem. Additionally, the user equipment and the mobile management entity (“MME”) 11 include a non-access stratum (“NAS”) subsystem.

The physical layer subsystem supports the physical transport of packets over the LTE air interface and provides, as non-limiting examples, cyclic redundancy check (“CRC”) insertion (e.g., a 24 bit CRC is a baseline for physical downlink shared channel (“PDSCH”)), channel coding (e.g., turbo coding based on QPP inner interleaving with trellis termination), physical layer hybrid-automatic repeat or retransmit request (“HARQ”) processing, and channel interleaving. The physical layer subsystem also performs scrambling, such as transport-channel specific scrambling, on a downlink-shared channel (“DL-SCH”), broadcast channel (“BCH”) and paging channel (“PCH”), as well as common multicast channel (“MCH”) scrambling for all cells involved in a specific multimedia broadcast multicast service single frequency network (“MBSFN”) transmission. The physical layer subsystem also performs signal modulation such as quadrature phase shift keying (“QPSK”), 16 quadrature amplitude modulation (“QAM”) and 64 QAM, layer mapping and pre-coding, and mapping to assigned resources and antenna ports. The media access layer or MAC performs the HARQ functionality and other important functions between the logical transport layer, or Level 2, and the physical transport layer, or Level 1.

Each layer is implemented in the system and may be implemented in a variety of ways. A layer such as the PHY in the UE may be implemented using hardware, software, programmable hardware, firmware, or a combination of these as is known in the art. Programmable devices such as DSPs, RISC, CISC, microprocessors, microcontrollers, and the like may be used to perform the functions of a layer. Reusable design cores or macros as are provided by vendors as ASIC library functions, for example, may be created to provide some or all of the functions and these may be qualified with various semiconductor foundry providers to make design of new UEs, or e-Node B implementations, faster and easier to perform in the design and commercial production of new devices.

The e-UTRAN system architecture has several significant features that impact timing in the system. A transmission time interval (“TTI”) is defined and users (e.g., UE or mobile transceivers) are scheduled on a shared channel every TTI. The majority of UE or mobile transceivers considered in the implementation of the e-UTRAN are full duplex devices. These UEs can therefore receive control and data allocations and packets from the e-NODE B or base station they are connected to in any subframe interval in which they are active. The UE detects when resources are allocated to it in the allocation messages on the physical downlink control channel (PDCCH). When downlink resources are allocated to a UE, the UE can determine that data or other packets are going to be transmitted towards it in the present frame or in coming frames. Also, the UE may have uplink resources allocated to it. In this case, the UE will be expected to transmit towards the e-Node B in coming frames on the uplink based on the allocated UL resources.

Additional timing related services are present in the environment. The e-UTRAN communications environment supports VoIP communications. The use of VoIP packets creates another cyclic pattern within the system. A typical cycle for VoIP would be 20 milliseconds, although 40 milliseconds, 60 milliseconds and 80 milliseconds may also be used in case packet bundling. 20 milliseconds as a VoIP interval will be used as a non-limiting default example for VoIP packets throughout the rest of this specification text. Further, the e-UTRAN communications system provides automatic retransmission request (ARQ) and hybrid automatic retransmission request (HARQ) support. The HARQ is supported by the UE and this support has two different dimensions. In the downlink direction, a synchronous HARQ is supported. However, the uplink or UL channel is a different standard channel that uses single carrier FDMA (SC-FDMA) and as currently provided, requires a synchronous HARQ. That is, in the uplink direction, after a packet is transmitted to the eNB, an ACK/NACK (acknowledged/not acknowledged) response is transmitted by the eNB towards the UE a definite time period later, after which the UE, in case NACK was received, will retransmit the packet in UL direction in a given sub frame after a predetermined delay.

The e-UTRAN specifications support air interface signaling using both frequency division duplex (FDD), where uplink (signaling from the UE to the eNB) and downlink (signaling from the eNB towards the UE) can occur at the same time but are spaced apart at different frequencies; and time division duplex (TDD), where the UL and DL frames are communicated on the same carrier but spaced apart in time. Of particular interest to the embodiments of the present invention are the frame structures of TDD radio frames. The frame structures have been selected so that TDD and FDD services may be supported in the same environment and dual-mode devices may be easily implemented. The selection of the FDD or TDD services may depend on the type of data, whether the data transmission is asymmetric (for example, internet browsing tends to be very heavy on the downlink, while voice may be more or less symmetric on both downlink and uplink) the environment, and other parameters. There are advantages and disadvantages to each that are known to those skilled in the art. The technical specifications (TS) document entitled “3GPP TS 36.300” version 8.5.0 (2008-05), available from the website www.3gpp.org, and hereby incorporated by reference in its entirety herein provides in part the specifications for the physical interfaces for the E-UTRAN networks.

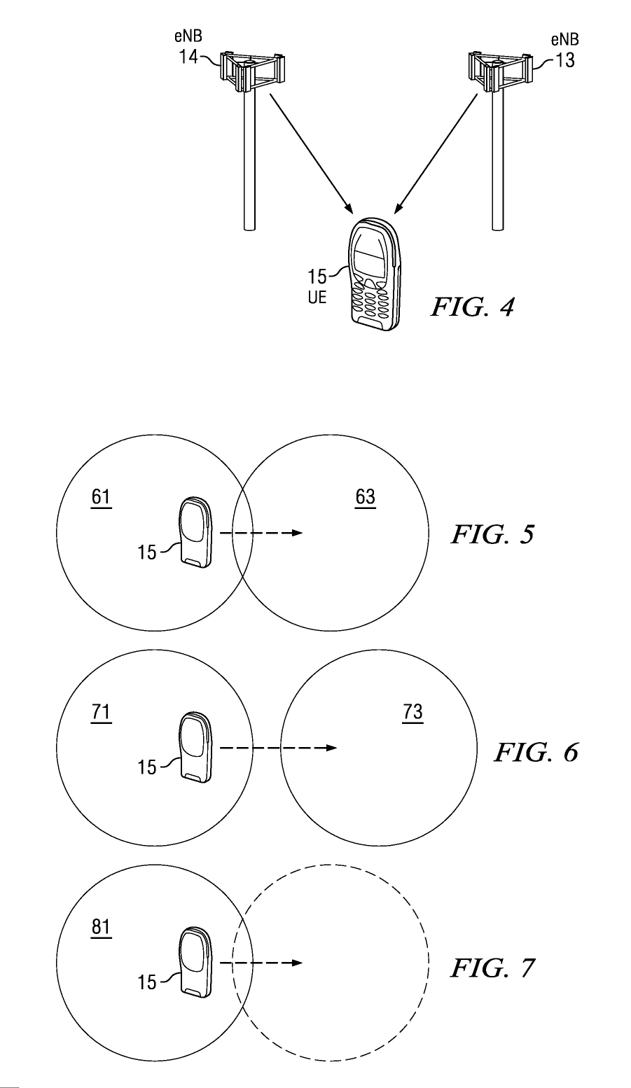

FIG. 4 depicts a simplified system level diagram of an example communications system. FIG. 4 provides an illustration of an environment and structure for application of the principles of the present invention. UE 15 is able to receive signals from eNBs 13 and 14. In an “idle” mode, the UE may select one of these as a serving cell, or “camp” on one of the eNBs. The UE 15 may also record the received signal strength of the other eNB and record it. This information may then be used if a reselection process is indicated. Reselection can occur if the signal strength from the serving cell decreases; for example, if the UE moves location, if the serving cell becomes very busy, if the serving cell malfunctions, or on some commands from the eNB or some reconfiguration by the radio resource controller (RRC).

Embodiments of the present invention provide, in an enhanced UE configuration, a framework that supports SON algorithms as presently proposed. To date, no proposal has been made in the art that provides UE operations to support the SON functionality defined for future implementations of the NGMN or LTE Advanced next generation networks.

When a mobile UE is in idle mode, that is, when no RRC connection is active, the UE periodically performs a cell reselection process. For example, as the UE moves out of or away from the currently selected eNB (the “serving cell”) coverage, the receiver at the UE will determine that the received signal power is decreasing. When certain configurable signal thresholds are reached, the UE will perform a reselection process. This is done by determining, using signal strength at the receiver, the nearest neighbors. Based on the power measurements performed by the UE as currently defined by the 3GPP specifications, the UE may reselect a new serving cell from a neighboring cell during terminal mobility. The reselection process as presently provided has a focus on determining the best neighboring cell to select for best service in the UE.

In embodiments of the present invention, a set of functions for an enhanced UE are provided that extend the results of the reselection process to support SON algorithms at the network level. A set of different reselection events or outcomes may be defined. The one of the set identified for a particular reselection process depends on the reselection outcome; that is, whether it is successful or not, and depends on different determinations made during the reselection process. Embodiments of the invention provide for enhanced UEs configured to store these reselection events in a memory in the form of an event log or report. By forming the entries of the log to provide the information most useful to the network SON algorithms, and by signaling the event log to the network, the UE may enhance the efficiency and the performance of the SON algorithms. Because only existing hardware features of the UE are utilized in the embodiments, no redesign of the UE or the system is required to use the embodiments and gain the advantages in system performance (although such redesigns are in fact alternative embodiments contemplated by the inventors that do fall within the scope of the claims). Instead, the embodiments may, in one alternative, be implemented by software modifications. However, additional memory or hardware implementation may also be provided as embodiments of the enhanced UE.

The UE events stored in the memory may be reported to the network at different times. For example, at certain times in the 3GPP specifications, the UE signals the network, e.g., during cell/location update procedures. The event log could be signaled to the network as part of these existing messages. Alternatively, the UE may receive a request for an uplink transmission containing, as data words, the contents of the reselection event log.

In alternative embodiments, the log may be formed using trigger or capture criteria to limit the stored events to those of interest to or needed by the SON algorithms. In other embodiments, filtering criteria are used where the transmitted or signaled events could be filtered by certain network provided criteria, and in additional embodiments, event reporting filters or criteria could determine when the UE should signal the log contents (or a filtered version thereof, in some embodiments) to the network.

The reselection procedure as defined by the 3GPP specifications is performed during UE mobility in idle mode (no active RRC connection). As the UE moves out of coverage of the current serving cell (the cell it is presently “camped” on), the UE starts to measure the neighboring cells that are available in terms of received signal power. Neighbor cell measurements are periodically performed by the UE based on a neighbor cell list. This list could be provided to the UE by the network. When the measured power of the present serving cell (termed RSCP and measured in dBm) decreases and there is a stronger neighbor cell available, the UE determines to perform a reselection. The UE decides, based on the relative signal strengths and the measure of the signal strengths against certain thresholds provided by the network, to reselect a neighboring cell as the serving cell and “camp” on it. Note that in the present 3GPP, both the present serving cell and the neighboring cell are evaluated against a minimum serving cell threshold provided by the network, as well as the relative comparison performed between the cells. However, embodiments of the present invention do not require any particular criteria be used and are not limited to the examples provided here or by present 3GPP specifications.

Embodiments provided herein enhance the UE functionality by providing a framework wherein the UE can support the performance of SON algorithms at the network level. The prior art does not provide any such UE functionality.

As an example framework, in one non-limiting embodiment, the following events from the reselection procedure performed by a UE in idle mode are defined:
a) CELL_RESELECTION_EVENT-0: a reselection success (strongest neighbor cell found above the serving criteria threshold)
b) CELL_RESELECTION_EVENT_1: a reselection failure (channel or cell lost before reselection); (strongest neighbor found below the minimum serving power threshold criteria)
c) CELL_RESELECTION_EVENT_2: reselection failure, cell/channel lost (no neighboring cell detected above the receiver cell detection threshold)
d) Further, EVENT_0 may be subdivided into two separate events:
1. CELL_RESELECTION_EVENT_0_INTRA: reselection success, the serving cell power remained above a threshold called Snonintrasearch before reselection, and
2. CELL_RESELECTION_EVENT_0_NONINTRA: a reselection success, however the serving cell power fell below Snonintrasearch before reselection (reselection is an interfrequency or interRAT reselection)
   These example embodiment cell reselection events are described in more detail below.

FIG. 5 depicts, as an example in a simple diagram, the operation that results in Cell Reselection Event 0 (successful reselection). In FIG. 5, the UE 15 is shown moving from cell area 61 to cell area 63, but even as the serving cell power received is falling (as the UE moves away from that serving cell 61), the neighbor cell coverage area 63 which overlaps the edge area of the service cell coverage, begins and in this example, exceeds the required threshold. Thus, the UE can reselect the cell 63, the channel is not lost, and the reselection is successful. Note that as described above there are at least two possible cases within the Cell Reselection Event 0. First, the neighbor cell may be selected while the serving cell power still exceeds the higher threshold (above Snonintrasearch in FIG. 5). In this example, the UE does not have to search outside the frequency presently in use so this reselection is the best outcome in terms of system resources and effort used. Alternatively, the UE may successfully reselect to the neighbor cell while the power level of the serving cell is below the threshold Snonintrasearch level but still above the second threshold, the cell serving threshold limitation. This result is also a successful reselection but is characterized as an “interfrequency or interRAT” reselection, which may require additional effort and resources used. Still, these are both successful reselections, as the channel is not lost.

FIG. 6 illustrates another case, Cell Reselection Event 1. In FIG. 6, the UE 15 moves from the serving cell signal reception area 71 to another cell area 73, but before the UE can reselect, it loses the channel. That is, before reselection takes place, the serving cell signal received falls below the cell serving threshold. This case is a reselection failure, as the channel is lost.

FIG. 7 illustrates Cell_Reselection_Event_2. Here, as the UE 15 is moved from the serving cell reception area 81 and enters an area 83, no neighbor cell is detected at all and the receiver in the UE simply ceases detecting a cell. In this example, a coverage hole exists and the channel is also lost. Thus, this is another reselection failure case but no neighboring cell is identified at all.

The UE can store these events in its local memory for use by the system, and in particular by the radio resource controller (RRC) process and the system algorithms for SON can then read the stored information and utilize this information collected by the UE to optimize the network.

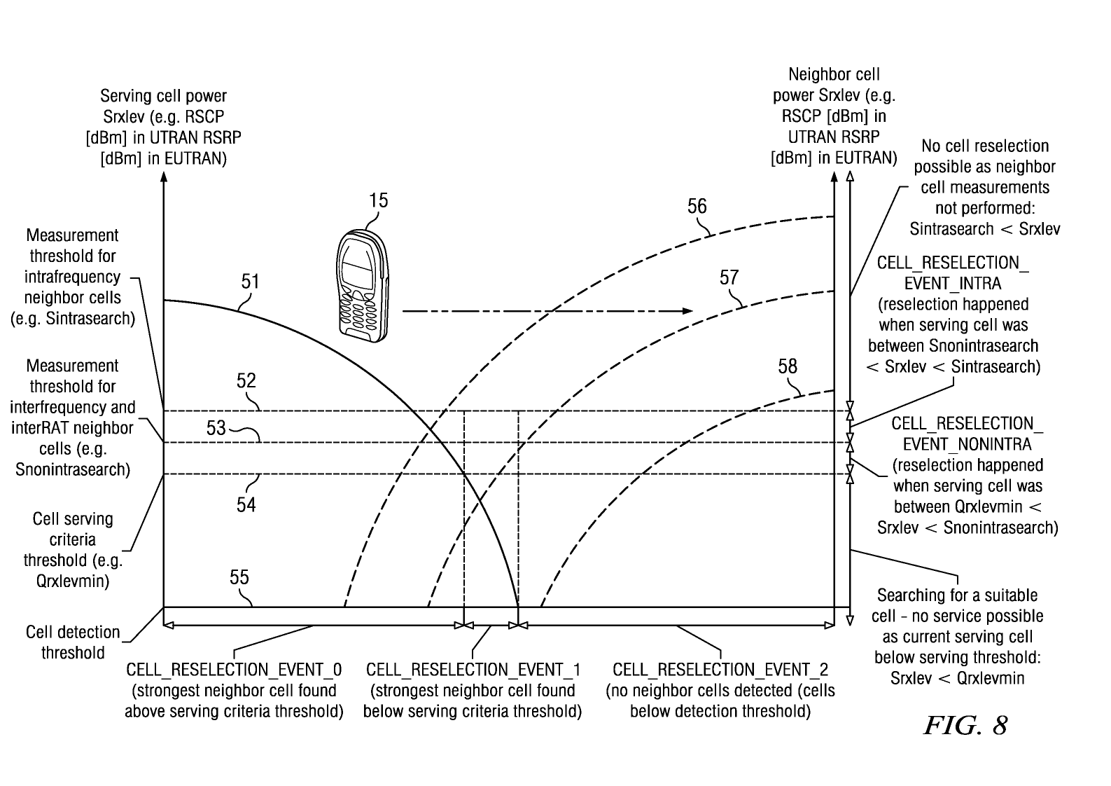

FIG. 8 depicts in a graphical form the events that may occur when a UE incorporating the embodiments performs cell selection and reselection. The left vertical axis depicts a minimum detection threshold, in dBm, for the UE to detect signals received from the initial serving cell. The right side vertical axis depicts, in dBm, the neighbor cell power detected by the UE receiver in two standards; UTRAN, which labels this received power as “RSCP”, and eUTRAN, which labels this received power as “RSRP”. The reselection events are identified along the bottom or x axis of the graph.

Labels on the left vertical axis represent, for non-limiting, illustrative examples, threshold received power levels the UE can determine for different observed received power. For example, the measurement threshold level for intrafrequency neighbor cells is labeled 52. The intrafrequency neighbor cells are cells using the same frequency, radio access technology (RAT) and parameters, the simplest cells to choose for reselection of the serving cell. The measurement threshold for interfrequency and interRAT (radio access technology) is usually lower and is labeled 53 in FIG. 8. The cell serving criteria minimum threshold is usually lower still and is labeled 54. This signal or power threshold may be referred to as a minimum threshold for quality receiving levels, referred to as Qrxlevmin, and cells with received observed signals below this level may not be selected by the UE. The minimum cell power threshold the receiver in the UE can detect is also labeled in the diagram as 55, the cell detection threshold (this threshold is HW receiver sensitivity dependent).

In the diagram of FIG. 8, as the UE moves to the right and away from the original serving cell (on the left vertical axis), trace 51 indicates the received power from the serving cell. As the UE 15 location changes, this received power level falls and crosses the differing thresholds 52, 53, and 54. Trace 56 indicates the neighbor cell power for a first case, trace 57 indicates a lower neighbor cell power and trace 58 indicates still a lower neighbor cell power. As the UE moves into the area for receiving the neighbor cell, the relative power levels of the serving cell and the neighbor cell are compared. When trace 51 intersects trace 56, a CELL_{—RESELECTION}_EVENT_0 occurs. This is a successful reselection where a neighbor cell is located with a received power above the serving criteria threshold. On the right axis, the events are labeled; here, a CELL_RESELECTION_EVENT_INTRA occurred; that is, the neighbor cell was successfully selected when the power threshold of the serving cell was between the threshold levels Snonintrasearch and Sintrasearch, so that the new cell was successfully reselected without loss of channel. When the solid trace 51 intersects the next neighbor trace 57, a CELL_RESELECTION_EVENT_1 occurs, where the neighbor cell is detected but the receiving cell power is already below the serving cell threshold, and the channel was lost. This is a reselection failure case. On the right axis, the label indicates that the reselection failed because, before the reselection occurred, the serving cell power (Srxlev) fell below the minimum serving threshold (Qrxlevmin) required. Finally, the solid trace 51 reaches the zero level, where the serving cell is no longer detected, before the trace intersects the trace labeled 58. In this case, a CELL_RESELECTION_EVENT_2 occurs; that is, no neighbor cells where detected, and the channel was lost, therefore, reselection failure occurs.

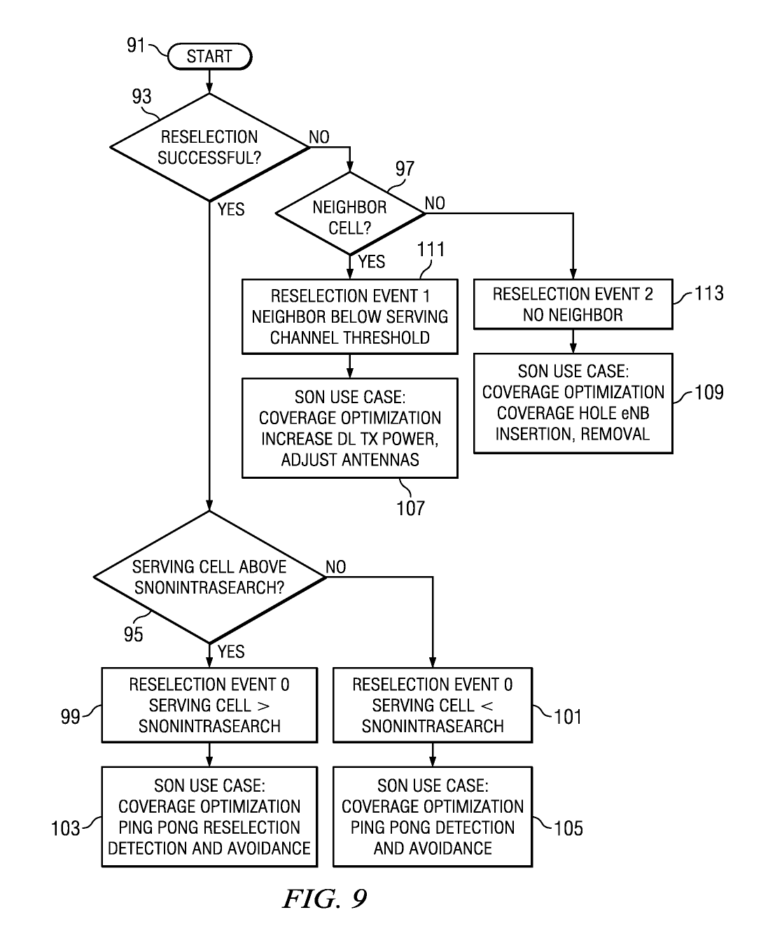

FIG. 9 presents in a flow chart form an event analysis method which embodiment UEs may perform. After a start state 91, a reselection is performed at state 93. If a cell reselection performed in a UE Idle mode is successful, the tree moves to the left side to state 95. If instead, the reselection is unsuccessful, the analysis tree moves to the right side to state 97. In state 95, the UE determines whether the serving cell was above the Snonintrasearch measurements threshold prior to reselection. If the answer is “yes”, the UE can record the event as RESELECTION EVENT 0 at state 99. The system may use this information for the SON case use input for Coverage Optimization, (e.g., ping pong reselection detection and avoidance). “Ping pong” reselection occurs when a UE reselects between two neighboring cells repeatedly, unnecessarily using system resources.

Continuing with the description of the UE analysis flow chart, at state 101, the successful reselection event 0 is recorded but the serving cell power was below the “Snonintrasearch” threshold prior to reselection, thus this event is recorded as a RESELECTION EVENT 0 event. The search included intrafrequency and interRAT cells. At states 103 and 105, the use case for the SON algorithms that would utilize this information is shown. In both of these EVENT_0 cases, the Coverage Optimization case with “Ping Pong reselection detection and avoidance” would utilize these reselection results.

In state 97, reselection failure has occurred and there are two possibilities. If a neighbor cell was identified before reselection, the flow transitions to state 111, where the UE records a RESELECTION EVENT 1, where a neighbor was identified but the serving cell fell below the serving cell criteria prior to reselection and the channel was lost. State 107 identifies the SON usage case that would benefit from this information; the Coverage Optimization case, where the network can direct the eNBs to increase downlink transmit powers, or tilt their antennas to increase coverage between them. In state 113 of FIG. 9, the UE did not find a neighbor cell prior to reselection. This is reported by the UE as a RESELECTION EVENT 2. In state 109, the SON use case that would benefit is identified as the Coverage Optimization case, Coverage Hole management, and the network could recommend eNB insertion or removal to fill this coverage hole.

Importantly, when the UE performs a reselection attempt, the location information and date and time information are available. This, in combination with the cell reselection events identified, can provide the SON algorithms executing in the network with the information needed to make adaptive changes to the network and therefore perform self optimization as proposed in the current standardization documents.

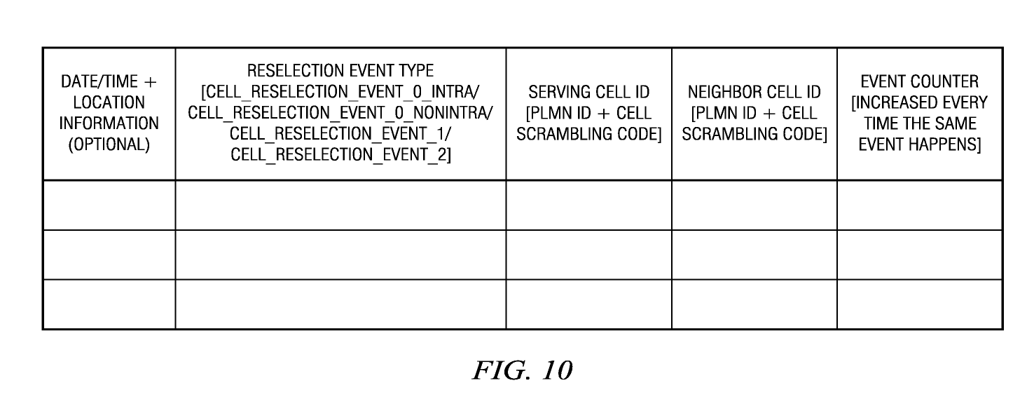

FIG. 10 depicts one illustrative and non-limiting embodiment of a table format that the UE may use to record the events in a stored event log. However, the reader should understand that the embodiments are not limited to this example, and alternative forms of event storage are contemplated as alternative embodiments and are part of the invention and within the scope of the claims presented herein.

FIG. 10 depicts the fields the UE may store in this example. In the first column the date and time and location may be stored. In the second column, the reselection event type may be stored. Note that since there are four types defined, two bits may be used to identify the type; alternatively, additional words or bits could be provided, for example, for CRC checking or encryption. In the third column, the unique ID of the serving cell (eNB) is recorded. In the fourth column, the neighbor cell or cells are recorded. In the last column, an event counter is kept. This is used to identify repeated reselections, of significance in eliminating the “ping pong” problem by adjusting, for example, and transmit power in two neighbor cells to avoid UEs constantly reselecting. The order of the columns is not restricted to this illustrative example.

The table may be signaled to the network via an uplink message transmitted from the UE. For example, this may occur at typical signaling times, or it may occur on request or command by the network. In any event, the UE can provide focused event information to support the SON use cases, or to drive test minimization. As described above, each of the four reselection events is used for different Coverage Optimization cases in the proposed SON algorithms.

The use of the embodiments provides information to the network from the UE that has not previously been made available. To take advantage of the features of the embodiments, the network should be able to receive, store, process and analyze the cell reselection information made available to it by the UE. These processing steps may be performed in a centralized location or in a distributed manner by network entities. The information may be used for SON algorithms or for drive test minimization, or for network analysis to identify, for example, coverage holes and neighbor cell problems.

In some embodiments, the network may provide to the UE some event processing criteria. These may be used to more efficiently leverage the UE capabilities. Some criteria could be, for example:

1) Event storing:
a) Event types to store in UE memory (for one illustrative and non-limiting example, the network may be interested only in unsuccessful/successful reselections)
b) Events related to a particular cell reselection type (for example, intrafrequency, interfrequency, interRAT)
c) Events related to particular cells (e.g. by cell IDs)

2) Event filtering:
a) the network may, for example, be interested only in events which happened during a date or a particular time window
b) the network may configure the UE to filter by time differences between events
c) the UE may be configured to filter by event pattern

3) Event reporting:
a) The event reporting threshold may be set to count events and report on a threshold being met
b) Events reporting frequency may be configured to report immediately, or never, or at some interval after service is lost, at a reset, when UE is being charged, etc.
c) Event reporting can be triggered by a pattern matching, by command from the network, by a timeout, a counter, or in some conditions automatically by the UE or the network

The embodiments of the invention provide many advantages. By adding enhanced idle mode measurements events to the operation of the UEs, the embodiments may significantly support and enable the SON algorithms as proposed by the 3GPP/NGMN use cases. The embodiments may also support the 3GPP drive test minimization case. The embodiments may be implemented in existing or in design devices using only software modifications, so that no expensive hardware redesign is necessary. In the alternative, the embodiments may be implemented in hardware and software and any combination of these. The embodiments do not add power consumption over existing UE operations, as the recording of the reselection events is added to reselection that is already in place, so the power to perform the reselection process is already being consumed in the prior art approaches. The embodiments may be added to existing standards and implemented industry wide. However, even if the use of the embodiments is not universal, the UEs providing the embodiments will interoperate with other UEs and eNBs that do not support the features without error, no compatibility issues will arise.

While the embodiments of the invention have also been described above with a focus on the operation of a UE in a 3GPP eUTRAN communications system, the embodiments may be applied to other mobile devices in other communications systems where the mobile device must connect to one, and then another, cell serving terminal. Thus although the examples above were provided in the context of, and using the terminology associated with, the 3GPP standards, the invention and the embodiments are not so limited, and the claims cover systems other than UTRAN, eUTRAN and 3GPP standard systems. Generally, a mobile receiver in an embodiment system may perform the methods to measure neighbor cells during reselection operations and store those measurements, then the network may retrieve the stored measurements for use in analyzing and self organizing/optimizing the network.

The embodiments may be implemented using programmable processors and executable software. For example, the embodiments may be implemented as a computer readable storage product, comprising executable instructions which, when read and executed by a programmable communications terminal, cause the programmable communications terminal to perform storing the cell reselection event type in a memory on board the programmable communications terminal. The computer readable storage product may be provided as a flash drive, disk, optical disk, hard drive, file, internet download or other machine readable format.

Although various embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, and composition of matter, or means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for operating a communications system, comprising:
providing a mobile communications terminal;
receiving a first signal from a first fixed communications terminal over an air interface;
that the first signal is beneath a predetermined threshold;
receiving a second signal from a second fixed communications terminal over the air interface;
attempting to select the second fixed communications terminal as the serving cell station for the mobile communications terminal; and
storing a cell reselection event in a memory within the mobile communications terminal.

2. The method of claim 1, further comprising:
determining that the second terminal is selected as the serving cell station for the mobile communications terminal;
determining the signal strength of the first signal at the time the second fixed communications terminal was selected; and
recording a cell reselection event type corresponding to the determining.

3. The method of claim 2, wherein the recording of a cell reselection event type further comprises:
receiving a signal strength threshold indicating an interfrequency search;
determining the signal strength at the time the second fixed communications terminal was selected exceeds the signal strength threshold; and
storing a cell reselection type indicating a non-intrafrequency reselection was successful.

4. The method of claim 2, wherein the recording of a cell reselection event type further comprises:
receiving a signal strength threshold indicating an interfrequency search;
determining the signal strength of the first terminal at the time the second fixed communications terminal was selected did not exceed the signal strength threshold; and
storing a cell reselection type indicating a non-interfrequency reselection was successful.

5. The method of claim 1, further comprising:
receiving a minimum cell serving criteria threshold;
receiving a second signal from the second fixed communications terminal;
determining the strength of the first signal and second signal are below the minimum cell serving criteria threshold; and
storing a cell reselection type indicating a second fixed cell was identified and reselection was unsuccessful.

6. The method of claim 1, further comprising:
receiving a minimum cell serving criteria threshold;
determining the strength of the first signal received from the first fixed communications terminal is below the threshold;
determining that no signal from another fixed communications terminal is received; and
storing a cell reselection type indicating reselection was unsuccessful and no second fixed communications terminal was identified.

7. The method of claim 1, further comprising signaling the stored cell reselection event to a fixed communications terminal over the air interface.

8. The method of claim 1, further comprising signaling the stored cell reselection event to a fixed communications terminal over the air interface responsive to a command received from the air interface.

9. A mobile communications terminal, comprising:
a memory;
at least one antenna configured to receive and transmit signals over an air interface;
a transceiver coupled to the at least one antenna and configured to transmit and receive signals over the air interface; and
a processor coupled to the transceiver and configured to receive signals over the air interface from a first fixed communications terminal, and to receive signals over the air interface from a second fixed communications terminal, further configured to determine whether the signal received from the first communications terminal exceeds a predetermined threshold, further to connect to the second fixed communications terminal over the air interface when the signal from the first communications terminal is below a predetermined threshold, and to store a cell reselection event in the memory.

10. The mobile communications terminal of claim 9, further comprising:
a first measurement threshold stored in the memory indicating when a reselection process is needed;
a second measurement threshold stored in the memory indicating that an interfrequency and intraRAT search may be performed; and
a third measurement threshold stored in the memory indicating a minimum received signal strength for a serving or neighbor cell.

11. The mobile communications terminal of claim 9, wherein:
the processor is further configured to detect a signal from the second fixed communications terminal;
the processor is configured to detect when the signal from the first communications terminal is below the first measurement threshold;
the processor is configured to determine whether the signal from the second fixed communications terminal exceeds the third measurement threshold; and
responsive to the determining, the processor is configured to store a cell reselection event indicating a successful reselection event in the memory.

12. The mobile communications terminal of claim 9, wherein the processor is configured to read the stored reselection events from the memory responsive to a received command.

13. The mobile communications terminal of claim 9, wherein the processor is configured to transmit the stored reselection events from the memory, responsive to a received command.

14. The mobile communications terminal of claim 9, wherein the processor is configured to transmit the stored reselection events from the memory, responsive to a predetermined time elapsing.

15. The mobile communications terminal of claim 9, wherein the processor is configured to transmit the stored reselection events from the memory upon detection of a particular pattern in the stored reselection events.

16. A fixed communications terminal, comprising:
a processor configured to perform a self organizing process on a network;
a transceiver coupled to an antenna for transmitting and receiving signals over an air interface;
a memory for storing data, responsive to the processor, the memory storing cell reselection event data received from a mobile communications terminal over the air interface.

17. The fixed communications terminal of claim 16, wherein the processor is configured to perform the self organizing process by transmitting command signals over the air interface to cause fixed elements to increase their transmit signals.

18. The fixed communications terminal of claim 16, wherein the processor is configured to perform the self organizing process by transmitting command signals over the air interface to cause fixed elements to decrease their transmit signals.

19. A computer readable storage product, comprising executable instructions which, when read and executed by a programmable communications terminal, cause the programmable communications terminal to perform:
receiving a first signal from a first fixed communications terminal over an air interface;
determining that the first signal is beneath a predetermined threshold;
receiving a second signal from a second fixed communications terminal over the air interface;
attempting to select the second fixed communications terminal as the serving cell station for the mobile communications terminal; and
storing a cell reselection event in a memory within the mobile communications terminal.

20. The computer readable storage product of claim 19, further comprising instructions which, when read and executed by the programmable communications terminal, cause the programmable communications terminal to perform:
transmitting the stored cell reselection event over the air interface.
